(19) United States
(12) Patent Application Publication
(10) Pub. No.: US 2026/0215648 A1
(43) Pub. Date: Jul. 30, 2026

(54) Pressure washer

(71) Applicant: Greenworks (Jiangsu) Co., Ltd., Changzhou (CN)

(72) Inventors: Guangda ZHAO, Changzhou (CN); Kaihong TANG, Changzhou (CN); Hailong HUANG, Changzhou (CN); Chunlin ZHAO, Changzhou (CN); Yuanjian CUI, Changzhou (CN)

(73) Assignee: Greenworks (Jiangsu) Co., Ltd., Changzhou (CN)

(21) Appl. No.: 19/564,155

(22) Filed: Mar. 11, 2026

Related U.S. Application Data
(63) Continuation of application No. PCT/CN2024/118748, filed on Sep. 13, 2024.

(30) Foreign Application Priority Data
Sep. 15, 2023 (CN) 202322509206.4
Sep. 15, 2023 (CN) 202322510576.X
Sep. 15, 2023 (CN) 202322524531.8
Sep. 15, 2023 (CN) 202322525792.1

(51) Int. Cl. A47L 11/40; B05B 9/08

(52) U.S. Cl. CPC A47L 11/4088; A47L 11/4008; B05B 9/0855

(57) ABSTRACT

A pressure washer includes a housing, a motor assembly, a pump assembly, a switch assembly, and a hose fixing device. Wherein, the motor assembly is disposed in the housing, the pump assembly is also disposed within the housing, and the motor assembly and the pump assembly are configured to be arranged longitudinally. The switch assembly is located between the motor assembly and the pump assembly, and is fixedly coupled to the pump assembly and the housing respectively. The hose connector is mounted on the housing for fixing a hose connector. The pump assembly is coupled to the hose connector to pump an external water source to the pressure washer and discharge water out of a water outlet pipeline of the pressure washer.

### CROSS REFERENCE TO RELATED APPLICATION

The present application is a continuation application of PCT application No. PCT/CN2024/118748 filed on September 13, 2024, which claims the benefit of CN202322525792.1 filed on September 15, 2023, CN202322524531.8 filed on September 15, 2023, CN202322509206.4 filed on September 15, 2023, and CN202322510576.X filed on September 15, 2023. All the above are hereby incorporated by reference for all purposes.

### TECHNICAL FIELD

The disclosure relates to a pressure washer, which belongs to a technical field of cleaning.

### BACKGROUND

A high-pressure washer is a machine that enables a high-pressure plunger pump to generate high-pressure water through a power device (electric motor, gasoline engine, diesel engine) to rinse the surface of an object. It can remove and wash away dirt to clean the surface of the object. High pressure cleaning is also one of the most scientific, economical and environmentally friendly cleaning methods recognized in the world because of the use of high-pressure water jet to clean dirt.

At present, most pressure washers on the market are large in size, inconvenient to be carried and moved, occupy a large space, and are not easy to place.

In view of this, it is necessary to improve the conventional pressure washer to solve the above problems.

### SUMMARY

The disclosure provides a pressure washer, an internal structure of the pressure washer is compact, which not only increases a utilization rate of the internal space, but also greatly reduces a volume of the pressure washer, thereby making it more convenient to be carried and moved.

One or more embodiments of the disclosure provide the pressure washer, and the pressure washer includes a housing, a motor assembly, a pump assembly, a switch assembly and a hose fixing device.

The motor assembly is disposed within the housing.

The pump assembly is disposed within the housing, and the motor assembly and the pump assembly are configured to be arranged longitudinally.

The switch assembly is located between the motor assembly and the pump assembly, and fixedly coupled to the pump assembly and the housing respectively.

The hose fixing device is mounted on the housing and fix a hose connector.

Wherein, the pump assembly is coupled to the hose connector to pump an external water source to the pressure washer and discharge water out of a water outlet pipeline of the pressure washer.

In some embodiments, the housing includes a first housing and a second housing assembled with each other. The first housing and the second housing define an accommodating space, an air inlet and an air outlet are disposed on the first housing and/or the second housing, and airflow enters the accommodating space from the air inlet and exits from the air outlet.

In some embodiments, the motor assembly includes a motor housing, a motor body, a fan and a protective cover.

An accommodating cavity is disposed at one end of the motor housing.

The motor body is at least partially disposed in the motor housing.

The fan is coupled to the motor body and located in the accommodating cavity.

The protective cover is located at an end of the motor housing where the accommodating cavity is disposed, and the protective cover is fixedly coupled to the motor housing.

In some embodiments, the air inlet is disposed on a side of the housing away from the fan, and a separating part is disposed between the air inlet and the air outlet, to make the airflow enter the accommodating space before exiting from the air outlet.

In some embodiments, the air outlet includes a first air outlet and a second air outlet, the first air outlet is disposed on a side of the housing close to the fan, the second air outlet is disposed at a bottom of the housing, and the separating part is disposed between the air inlet and the second air outlet.

In some embodiments, a blocking plate is disposed at an end of the motor housing close to the accommodating cavity, the protective cover defines a first edge extending outward, a limiting part is disposed inside the protective cover, and when the protective cover is fixedly coupled to the motor housing, the blocking plate is accommodated in the protective cover and the limiting part abuts against the blocking plate.

In some embodiments, the hose fixing device includes a hose port and a control component.

The hose port is coupled to the hose connector.

The control component is disposed on one side of the hose port.

The hose connector is operately locked and unlocked by the control component.

In some embodiments, a positioning cavity is disposed on an outer side wall of the hose port.

The hose fixing device further includes a fixing member, the fixing member passes through the positioning cavity, a first end of the fixing member is fixed, a second end of the fixing member abuts against the control component, and the fixing member further includes a fixing part coupling the first end to the second end.

When the hose connector is released, the second end of the fixing member is pushed by an external force to cause the fixing part to be away from the positioning cavity, and when the hose connector is locked, the second end of the fixing member is free from the external force to allow the fixing part to remain in the positioning cavity.

In some embodiments, the housing has a first opening and a second opening, the control component is accommodated in the housing and passes through the first opening, and the hose port is accommodated in the housing and is exposed from the second opening.

In some embodiments, the control component includes a base part and a pushing part coupled to the base part, the base part comprises a pushing block, the pushing block passes through the first opening, a contacting surface between the pushing part and the second end of the fixing member is an inclined surface, and when the pushing block is pushed, the control component is pushed to move toward one side of the hose port to cause the second end of the fixing member to slide along the contacting surface.

In some embodiments, the fixing part extends along a pushing direction of the control component, both the first end and the second end extend along the insertion direction of the hose connector, and both the first end and the second end are substantially perpendicular to the fixing part.

In some embodiments, an separating plate is fixed at an end of the motor housing away from the fan, a clamping part is disposed at an edge of one of the motor housing and the separating plate, a mating part is correspondingly disposed at an edge of another of the motor housing and the separating plate, and when the separating plate is assembled to the motor housing from top to bottom, the mating part is matched with the clamping part.

In some embodiments, the clamping part is a rib disposed at an edge of the motor housing, the rib extends from top to bottom, the mating part is a groove formed at an edge of the separating plate, the groove also extends from top to bottom, and when the separating plate is assembled to the motor housing from top to bottom, the rib is accommodated in the groove and slidable along the groove.

In some embodiments, one of the motor housing and the separating plate is disposed with a guiding rail, another one of the motor housing and the separating plate correspondingly is disposed with a rail groove, the guiding rail is accommodated in the rail groove, the clamping part is a protruding rib disposed on the guiding rail, the mating part is a limiting groove disposed on an inner wall of the rail groove, and when the separating plate slides to a distance relative to the motor housing, the protruding rib is engaged in the limiting groove to fix the separating plate to the motor housing.

In some embodiments, the switch assembly includes a box, an operating component and a first switch component.

The operating component is coupled to the box and rotatable relative to the box. A first end of the operating component is accommodated in the box, and a second end of the operating component is located outside the box. The operating component includes a first operating block and a second operating block extending in different directions.

The first switch component is accommodated in the box, and includes a switch part facing one side of the operating component, and the switch part is switchable between a first state and a second state to activate and deactivate the first switch component.

When the first operating block abuts against a first end part of the switch part, a second end part of the switch part is tilted, the switch part is in the first state, and the first switch component is activated. When the operating component is rotated to enable the second operating block to abut against the second end part of the switch part, the first end part of the switch part is tilted, the switch part is in the second state, and the first switch component is deactivated.

In some embodiments, the first operating block extends in a first direction and the second operating block extends in a second direction perpendicular to the first direction, and outer wall surfaces of the first operating block and the second operating block on a side facing the switch part are both arc surfaces.

In some embodiments, a second switch component is further accommodated in the box, the second switch component includes a cantilevered elastic arm, a pre-made hole is formed on a side of the box facing the pump assembly, a portion of the elastic arm is exposed to the pre-made hole, the pump assembly includes a control part, and the control part extends into the pre-made hole to abut against the elastic arm to activate or deactivate the second switch component.

In some embodiments, a rotating component is fixed at one end of the operating component located outside the box, the housing defines a rotating hole adapted to the rotating component, and a portion of the rotating component passes through the rotating hole and rotatable in the rotating hole to drive the operating component to rotate.

In some embodiments, the operating component includes a first part accommodated in the box and a second part located outside the box, and the first operating block and the second operating block are both disposed on the first part.

In some embodiments, the box includes a first box and a second box, the first box and the second box are assembled with each other to form a mounting space, the operating component and the first switch component are both mounted in the mounting space, the first box includes a through groove for the operating component to pass through, a latching block protrudes from an outer side wall of the first box, a buckling part is correspondingly disposed on an outer side wall of the second box, and the buckling part is engaged with the latching block to assemble and fix the first box with the second box.

Beneficial effects of the disclosure are that: through a longitudinal configuration of the motor assembly and pump assembly, and disposing the switch assembly between the motor assembly and pump assembly and coupling the switch assembly to both the pump assembly and the housing fixedly, an internal structure of the pressure washer of the disclosure is more compact, which not only increases a utilization rate of the internal space, but also greatly reduces a volume of the pressure washer, thereby making it more convenient to be carried and moved.

### BRIEF DESCRIPTION OF THE DRAWINGS

FIG. 1 is a perspective structural view of a pressure washer according to at least one embodiment of the disclosure.

FIG. 2 is a schematic structural view of a pressure washer in FIG. 1 from another angle.

FIG. 3 is an exploded view of a pressure washer in FIG. 1.

FIG. 4 is an exploded view of a pressure washer in FIG. 3.

FIG. 5 is an internal schematic structural view of a pressure washer in FIG. 1.

FIG. 6 is a schematic structural view of a hose fixing device mounted on a second housing in FIG. 4.

FIG. 7 is an exploded view of FIG. 6.

FIG. 8 is an exploded view of a hose port and a fixing member in FIG. 7.

FIG. 9 is a schematic structural view of a motor assembly in FIG. 4.

FIG. 10 is an exploded view of a motor assembly in FIG. 9.

FIG. 11 is a schematic structural view of a protective cover in FIG. 10.

FIG. 12 is a schematic structural view of a motor housing in FIG. 10.

FIG. 13 is an exploded view of a motor housing, a stop part and a separating plate in FIG. 10.

FIG. 14 is a schematic structural view of a switch assembly in FIG. 4.

FIG. 15 is an exploded view of a switch assembly in FIG. 14.

FIG. 16 is a schematic structural view of an operating component in FIG. 15.

FIG. 17 is a schematic structural view of a switch assembly in cooperation with a pump assembly in FIG. 15.

### DETAILED DESCRIPTION

To enable objectives, technical solutions, and advantages of the disclosure to be clearer, the following describes the disclosure in detail with reference to the accompanying drawings and specific embodiments.

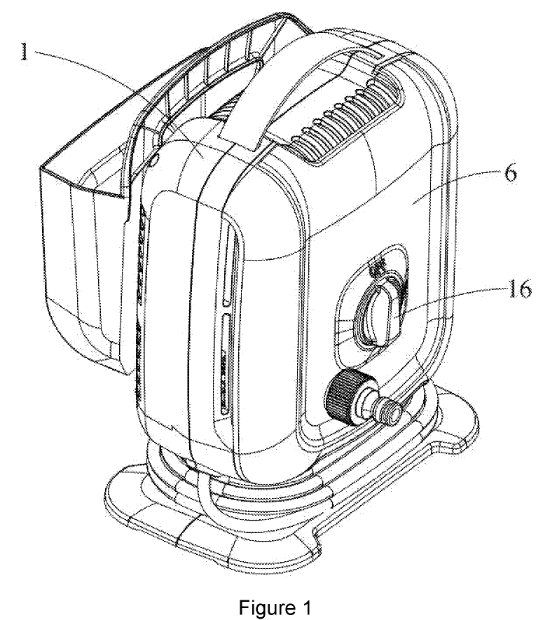

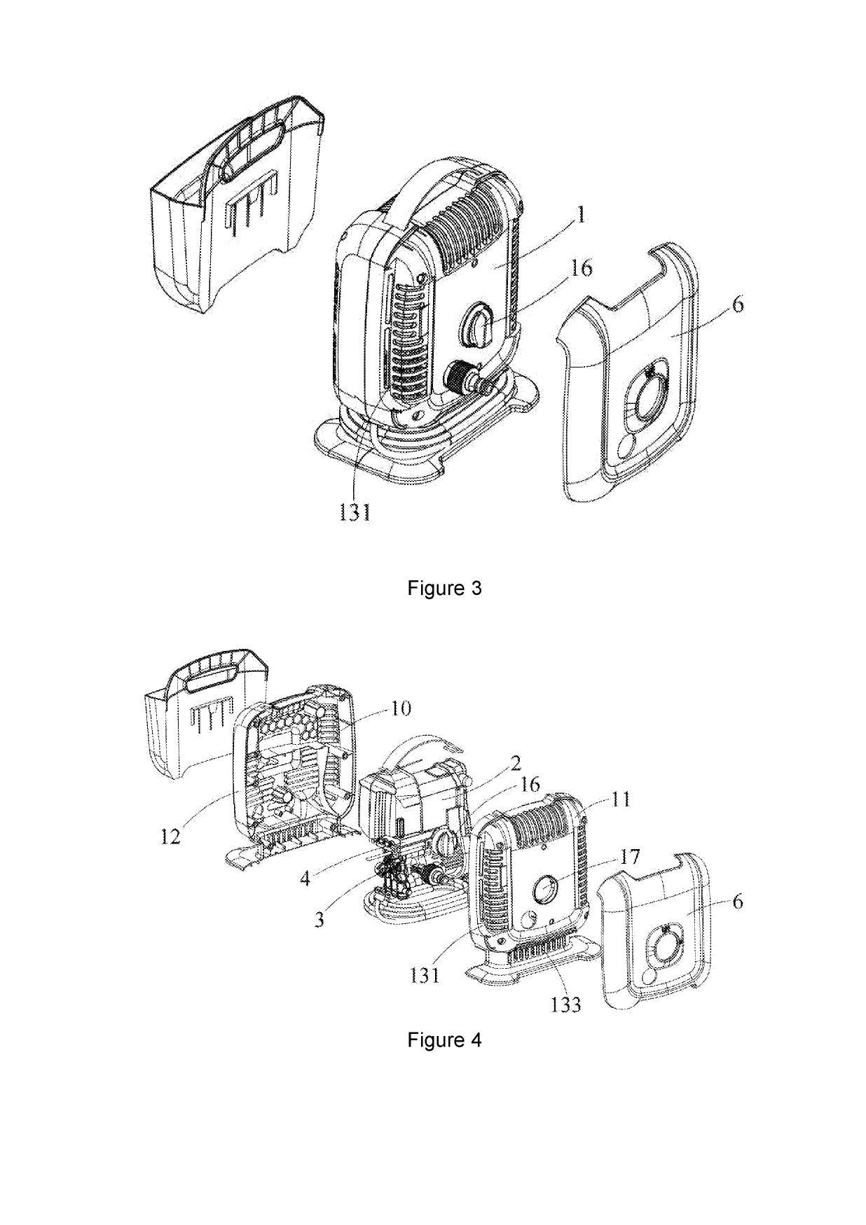

Please refer to FIG. 1 through FIG. 4. The disclosure provides a pressure washer, which includes a housing 1, a motor assembly 2, a pump assembly 3, a switch assembly 4 and a hose fixing device 15. Wherein, the housing 1 includes a first housing 11 and a second housing 12, the first housing 11 and the second housing 12 are assembled and fixed to each other, and an accommodating space 10 is formed between the first housing 11 and the second housing 12. The motor assembly 2, the pump assembly 3, the switch assembly 4 and the hose fixing device 15 are all accommodated in the accommodating space 10, and the motor assembly 2 and the pump assembly 3 are configured longitudinally.

The pressure washer of the disclosure needs to be coupled to a high-pressure hose connector (not shown), so that an external water source may be pumped to the pressure washer via the pump assembly 3 and the high-pressure hose connector, and then pumped out by a water outlet pipeline of the pressure washer to perform a high-pressure cleaning on an area to be cleaned. Therefore, a stability of the high-pressure hose connector is particularly important, so the pressure washer of the disclosure includes a hose fixing device to fix the high-pressure hose connector.

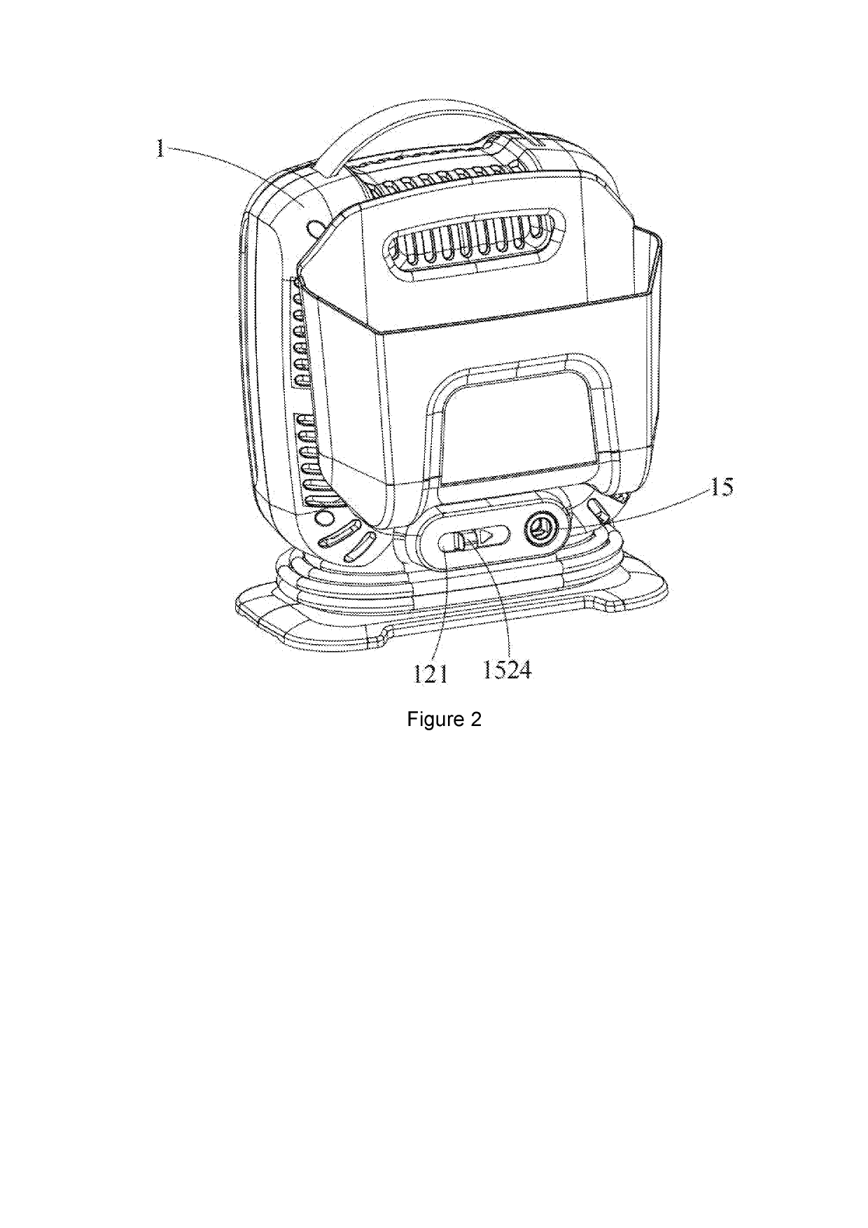

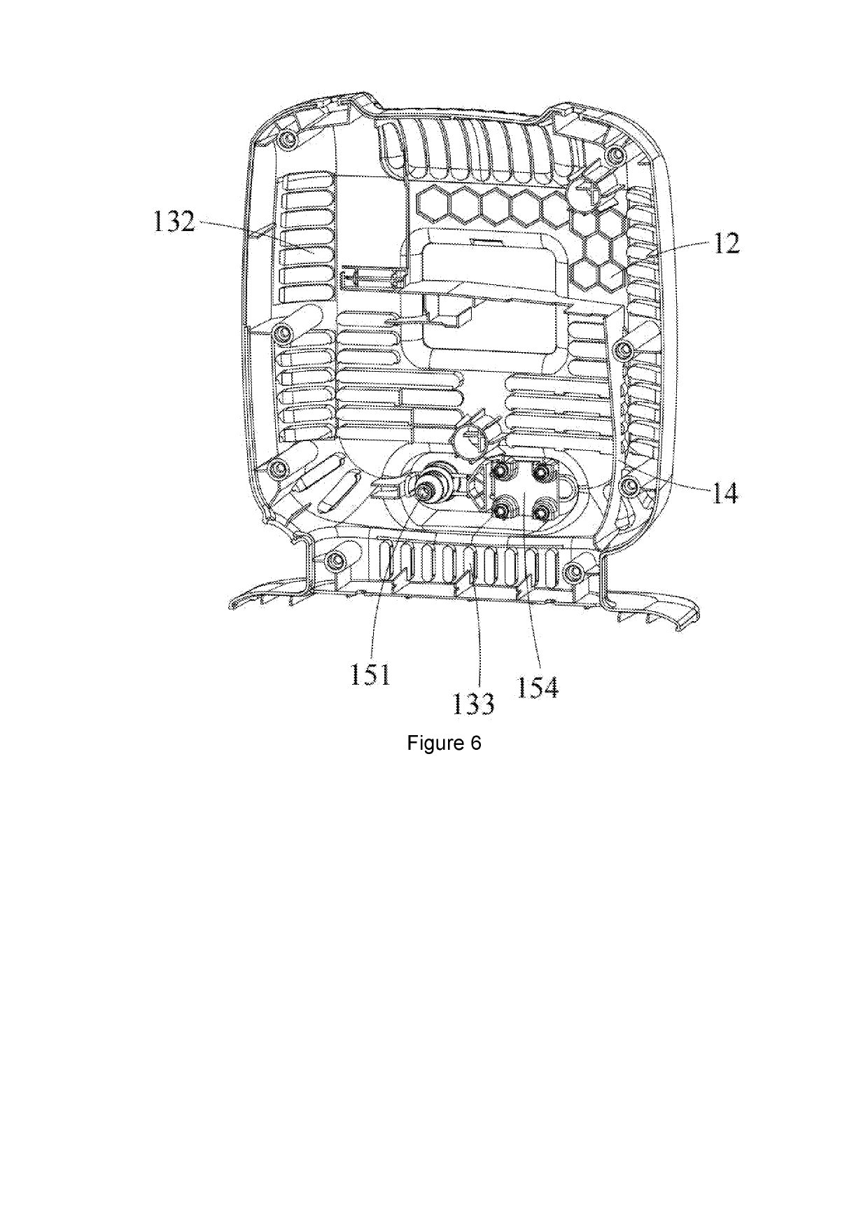

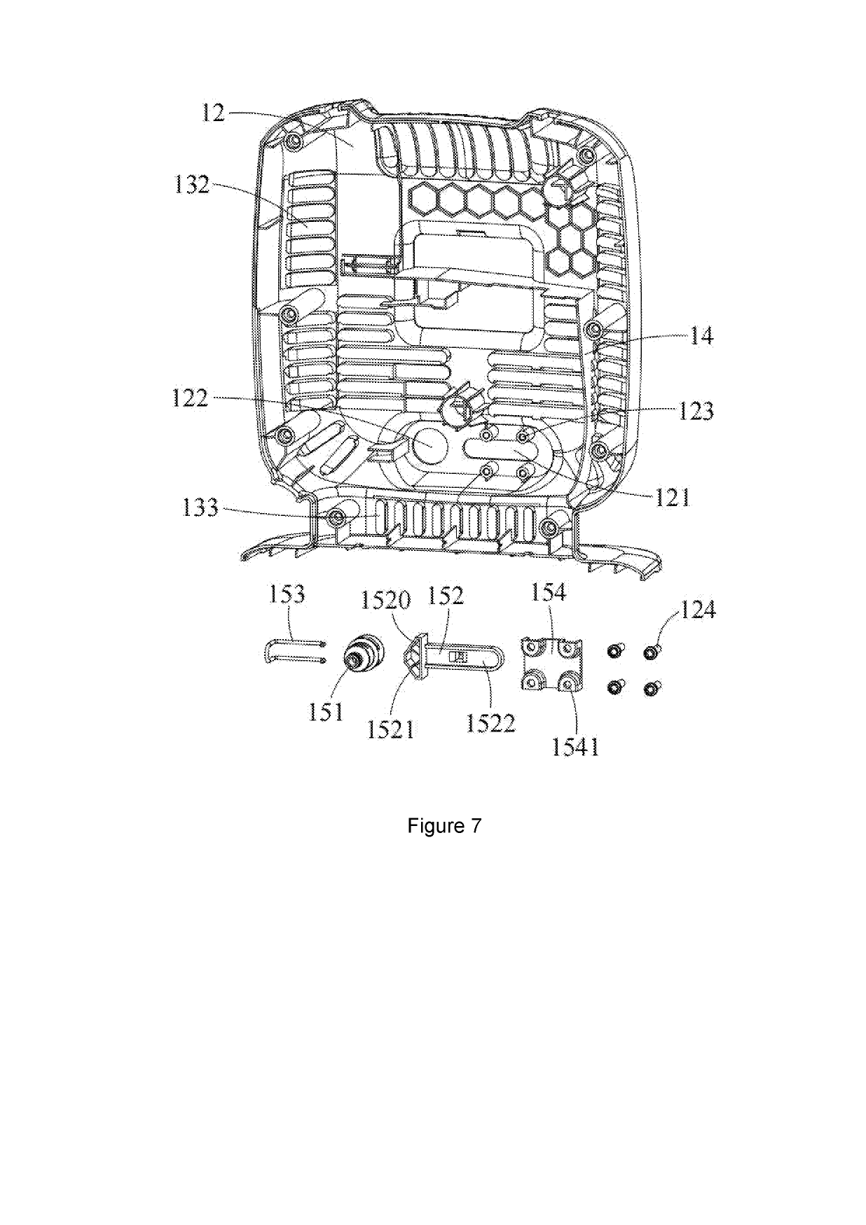

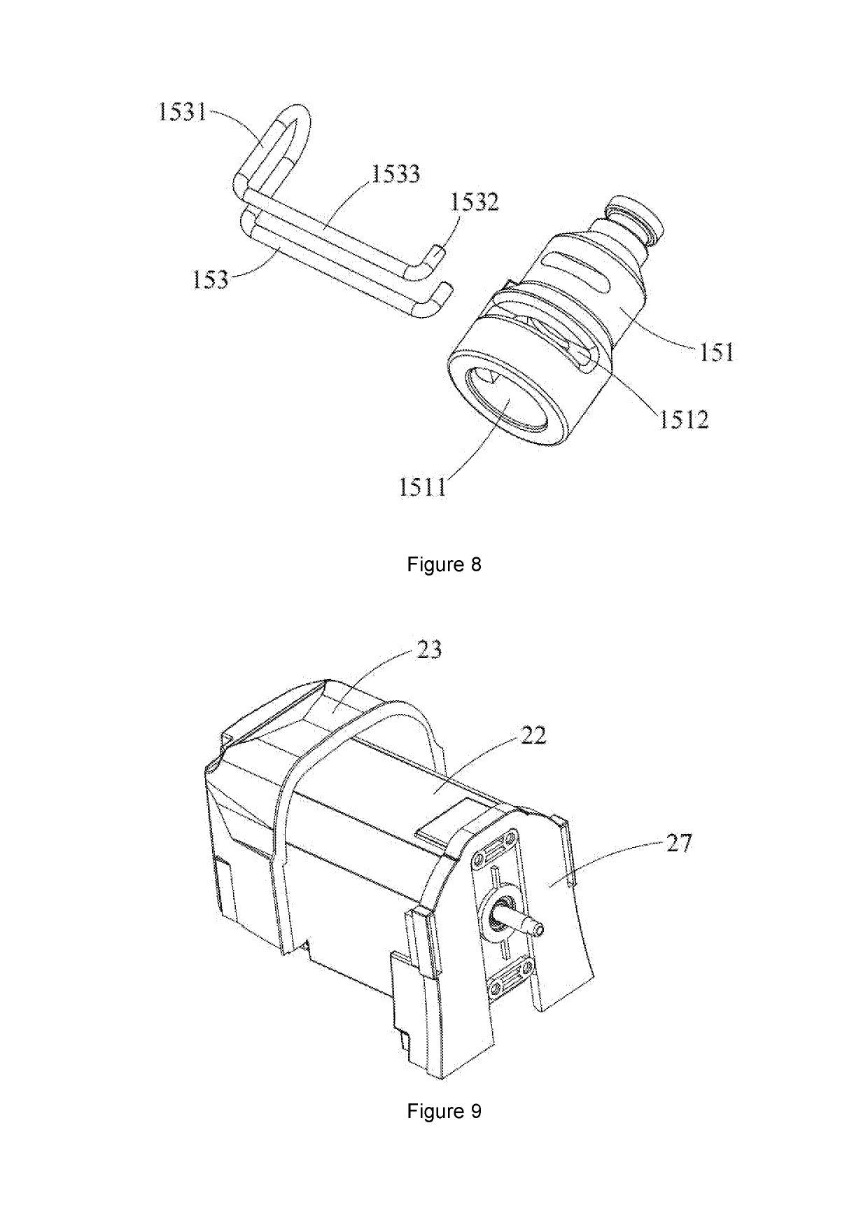

Please refer to FIG. 6 through FIG. 8 in combination with FIG. 2. It may be noted that the hose fixing device 15 may be used for a connection and fixing of most pipelines, which means adaptable to most hose connectors, and is not limited to high-pressure hose connector or to pressure washers. Hereinafter, the pressure washer of the disclosure will be described together for a clearer description.

The hose fixing device 15 includes a hose port 151, a control component 152 and a fixing member 153. The hose port 151 is adapted to a high-pressure hose connector and includes a plug-in cavity 1511 penetrating along an insertion direction of the high-pressure hose connector and a positioning cavity 1512 disposed on an outer side wall of the hose port 151. The positioning cavity 1512 is in communication with the plug-in cavity 1511. In this embodiment, there are two positioning cavities 1512, and the two positioning cavities 1512 are aligned with each other up and down.

The control component 152 is slidably fixed on the second housing 12 and disposed on one side of the hose port 151. When the hose connector is placed in the plug-in cavity 1511 and the control component 152 moves toward the hose port 151, the hose connector is gradually released, and when the control component 152 moves away from the hose port 151, the hose connector is gradually locked.

The fixing member 153 includes a first end 1531 and a second end 1532 opposite to each other and a fixing part 1533 coupling the first end 1531 to the second end 1532. The first end 1531 abuts against and is fixed to the second housing 12, the second end 1532 passes through the positioning cavity 1512 and abuts against the control component 152, and the fixing part 1533 is accommodated in the positioning cavity 1512 and a portion of the fixing part 1533 protrudes into the plug-in cavity 1511. When the hose connector is released, the second end 1532 of the fixing member 153 is pushed by an external force to cause the fixing part 1533 to be away from the positioning cavity 1512, and when the hose connector is locked, the second end 1532 of the fixing member 153 is free from the external force to allow the fixing part 1533 to remain in the positioning cavity 1512.

In an embodiment, when the control component 152 is pushed to move toward one side of the hose port 151, the second end 1532 of the fixing member 153 is pushed so that the fixing part 1533 moves toward an outside of the positioning cavity 1512, and the plug-in cavity 1511 is completely exposed. At this time, the high-pressure hose connector may be inserted into the plug-in cavity 1511. then, the control component 152 is released, so that the fixing member 153 drives the control component 152 to reset under an action of an own restoring force of the fixing member 153, and the fixing part 1533 is re-accommodated in the positioning cavity 1512 and clamps the high-pressure hose connector. At this time, the high-pressure hose connector is fixed in the plug-in cavity 1511. In this way, a synchronous fixation is completed while the high-pressure hose connector is inserted, which is not only convenient to use, but also does not need to add parts to ensure the fixation between the high-pressure hose connector and the hose port 151.

Of course, when the high-pressure hose connector needs to be pulled out, the control component 152 is also pushed to move towards one side of the hose port 151 first, so that the second end 1532 is pushed until the fixing part 1533 moves towards the outside of the positioning cavity 1512, and the plug-in cavity 1511 is completely exposed. At this time, the high-pressure hose connector may be pulled out of the plug-in cavity 1511, and then the control component 152 is released, so that the fixing member 153 drives the control component 152 to reset.

The control component 152 is U-shaped as a whole, and a contacting surface 1521 between the control component 152 and the second end 1532 of the fixing member 153 is an inclined surface, so that the second end 1532 of the fixing member 153 slides along the contacting surface 1521. Such configuration enables it to be very simple and easy for the fixing part 1533 to move toward the outside of the positioning cavity 1512.

In this embodiment, there are two first ends 1531, two fixing parts 1533, and two second ends 1532 symmetrically disposed with each other. The two first ends 1531 are coupled to each other, so that the fixing member 153 is U-shaped as a whole. The two first ends 1531 are abutted against and fixed to the second housing 12. The two fixing parts 1533 are respectively accommodated in the corresponding positioning cavities 1512 to jointly clamp the high-pressure hose connector. There are two contacting surfaces 1521 for the two second ends 1532 to abut against. Of course, in other embodiments, a specific shape of the fixing member 153 is not limited as long as a side facing the control component 152 is ensured to be an opening, so as to push the fixing part 1533 to move toward the outside of the positioning cavity 1512 and completely expose the plug-in cavity 1511.

The two contacting surfaces 1521 are combined to form a conical surface, so that the second end 1532 of the fixing member 153 may slide along the conical surface. Of course, in other embodiments, the contacting surfaces 1521 may also be an arc, and when a plane where a topmost end of the arc is located is higher than a plane where the positioning cavity 1512 is located, a fixation can also be released.

The control component 152 includes a base part 1522 and a pushing part 1520 coupled to the base part 1522. The base part 1522 includes a pushing block 1524, and the two control components 1521 are both disposed on a side of the pushing part 1520 facing the second end 1532. When the pushing block 1524 is pushed, the whole control component 152 is pushed to move toward one side of the hose port 151, and the two second ends 1532 slide along the corresponding control components 1521, so that a distance between the two second ends 1532 becomes larger and larger. This means that the two contacting surfaces 1521 enlarge an opening between the two second ends 1532, which releases a restriction of the fixing member 153 on the plug-in cavity 1511.

The fixing part 1533 extends along a pushing direction of the control component 152, both the first end 1531 and the second end 1532 extend along an insertion direction of the high-pressure hose connector, and both the first end 1531 and the second end 1532 are substantially perpendicular to the fixing part 1533. On one hand, a space inside the second housing 12 is saved, and on the other hand, a contact area between the second housing 12 and the control component 152 is increased, which improves fixing and pushing effects.

The second housing 12 defines a first opening 121 and a second opening 122, the control component 152 is accommodated in the accommodating space 10 to enable the pushing block 1524 to pass through the first opening 121, and the hose port 151 is accommodated in the accommodating space 10 and is exposed from the second opening. In this embodiment, the hose fixing device 15 is disposed on a back of the pressure washer, and a sliding distance of the pushing block 1524 is limited by the first opening 121, so that a positioning of the control component 152 is realized.

A mounting plate 154 is fixed on an inner side wall of the second housing 12, and there is a clearance (not shown) between the mounting plate 154 and the second housing 12. The base part 1522 is accommodated in the clearance, and the pushing part 1520 is located on an outer side of the mounting plate 154 and can abut against a side wall of the mounting plate 154 when the control component 152 is reset, thereby limiting a reset of the control component 152.

In an embodiment, the mounting plate 154 includes a hole groove 1541, and the second housing 12 correspondingly includes a screw hole 123, so that the mounting plate 154 can be fixed to the second housing 12 through a screw 124 passing through the hole groove 1541 and locking fit with the screw hole 123.

Please refer to FIG. 1 through 7. The first housing 11 and the second housing 12 both includes air inlets 131 and air outlets. A separating part 14 is disposed between the air inlets 131 and the air outlets, so that external airflow enters the accommodating space 10 from the air inlets 131 and then flows out from the air outlets under an action of the motor assembly 2. Since positions of the air inlets 131 and the air outlets on the first housing 11 and the second housing 12 substantially correspond to each other, a following description will be described in detail by taking the air inlet 131 and the air outlet on the second housing 12 as examples.

The air outlet comprises a first air outlet 132 and a second air outlet 133. The first air outlet 132 is disposed on a side of the second housing 12 opposite to the air inlet 131, which means that the air inlet 131 is disposed on a side of the second housing 12, and the first air outlet 132 is disposed on the other side of the second housing 12. The second air outlet 133 is disposed at a bottom of the second housing 12, and the separating part 14 is disposed between the air inlet 131 and the second air outlet 133. In this embodiment, the separating part 14 is a separating rib disposed inside the second housing 12, and the separating rib can ensure that the airflow entering from the air inlet 131 first enters the accommodating space 10, then passes through the motor assembly 2 and the pump assembly 3, and then flows out of the first air outlet 132 and the second air outlet 133, thereby avoiding a situation that the airflow directly flows out of the second air outlet 133 after entering from the air inlet 131.

The pressure washer further includes a cover plate 6, and the cover plate 6 at least partially covers the air inlet 131 to reduce water vapor in the external airflow from entering through the air inlet 131, thereby achieving a moisture-proof effect. In addition, the cover plate 6 can further function as a decorative plate, so as to cover the air inlet 131 and achieve an aesthetic effect.

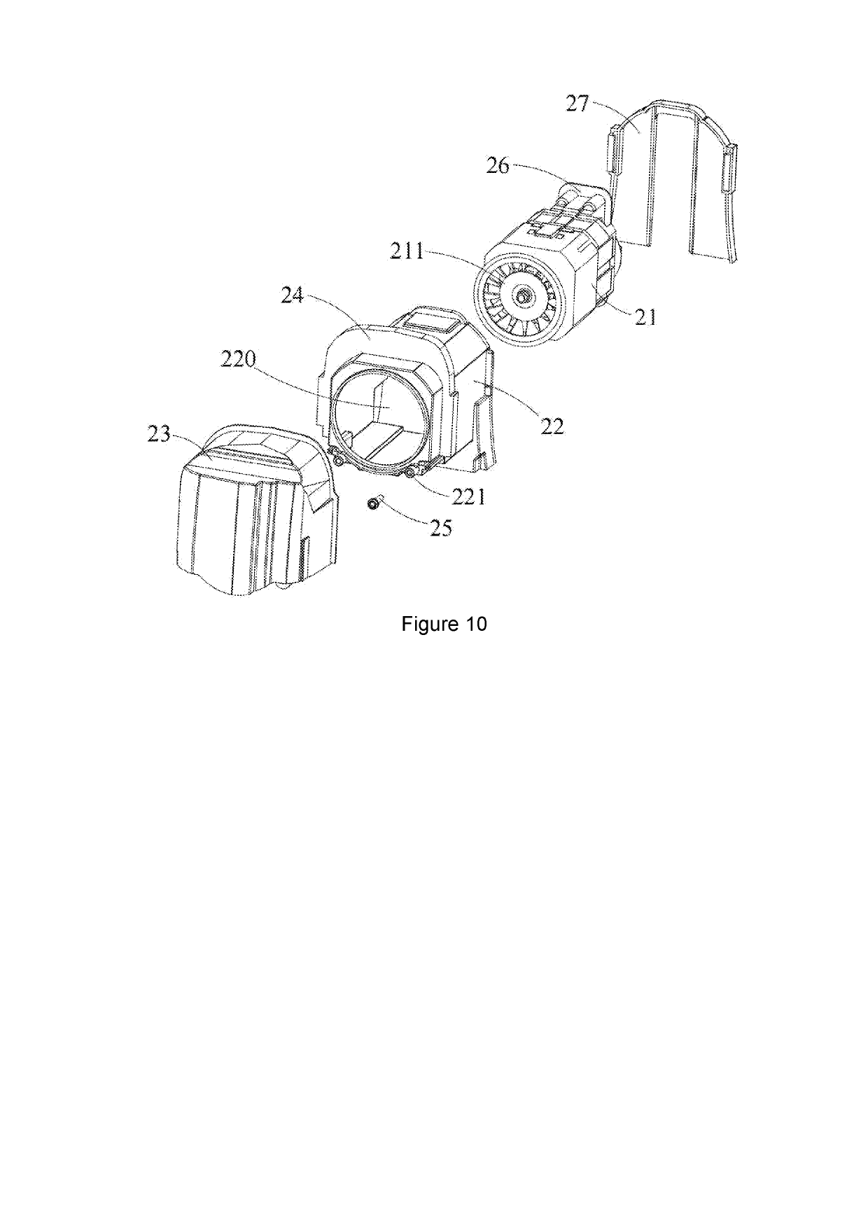

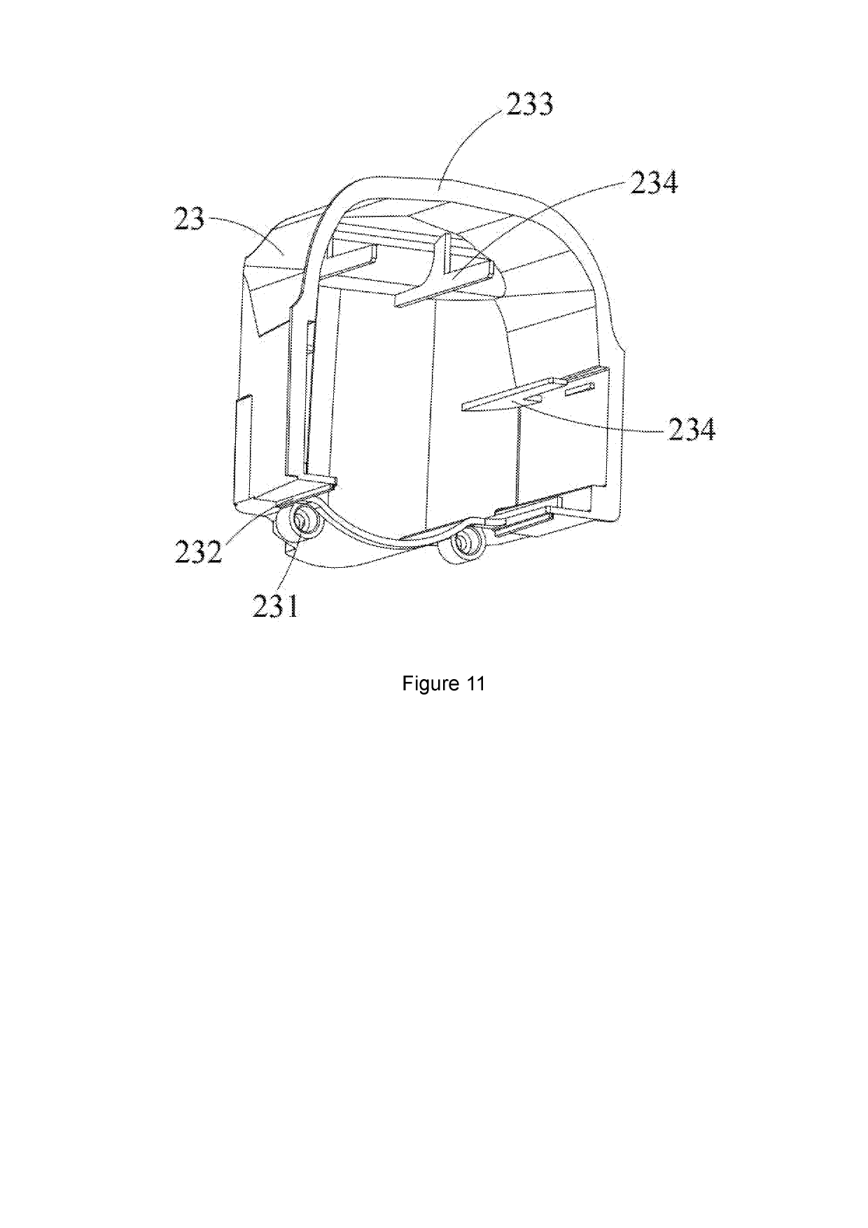

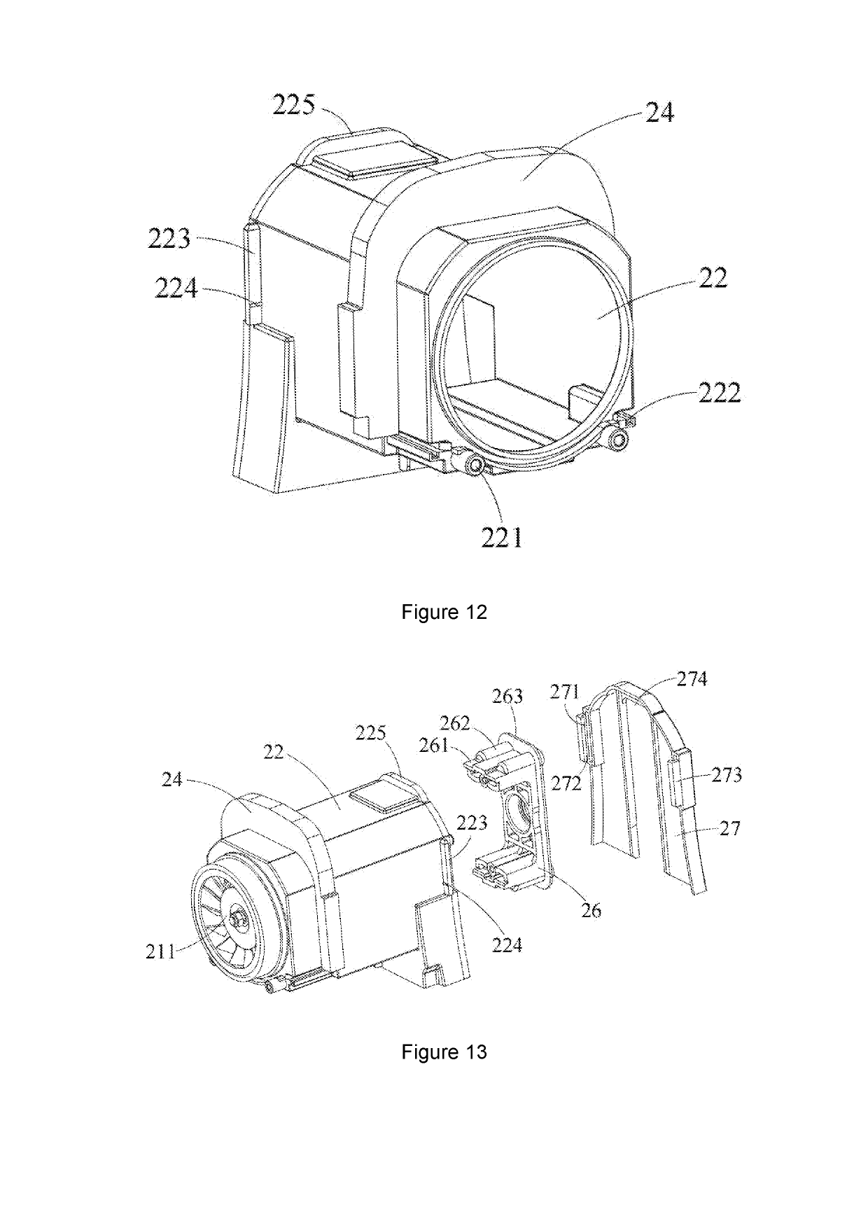

Please refer to FIG. 9 through FIG. 13, the motor assembly 2 includes a motor body 21, a motor housing 22, a fan 211, and a protective cover 23 that are accommodated in the accommodating space 10. The motor body 21 is at least partially accommodated in the motor housing 22, which means that at least a portion of the motor body 21 is disposed in the motor housing 22. At least one side of the motor housing 22 defines an opening, and one end of the motor housing 22 defines an accommodating cavity 220. The fan 211 is accommodated in the accommodating cavity 220 and axially coupled to the motor body 21, and the protective cover 23 covers the end of the motor housing 22 disposed with the accommodating cavity 220 and is fixedly coupled to the motor housing 22. In other words, through covering an outer side of the fan 211 with the protective cover 23, noise during an operation of the motor body 21 may be reduced, and a noise reduction effect is effectively achieved.

The protective cover 23 includes a first positioning part 231, the motor housing 22 correspondingly includes a second positioning part 221, and the protective cover 23 is fixedly coupled to the motor housing 22 through coupling the first positioning part 231 to the second positioning part 221. In an embodiment, the first positioning part 231 is a positioning groove disposed on the protective cover 23, the second positioning part 221 is a screw hole correspondingly disposed on the motor housing 22, and the first positioning part 231 is coupled to the second positioning part 221 via a positioning component 25. When the first positioning part 231 and the second positioning part 221 are aligned with each other, the external positioning component 25 passes through the first positioning part 231 and cooperates with the second positioning part 221 to realize a fixed connection between the protective cover 23 and the motor housing 22. In some embodiments, the positioning component 25 is a screw. Such a fixing manner has a simple structure and low costs.

One of the protective cover 23 and the motor housing 22 includes a sliding rail 232, another one of the protective cover 23 and the motor housing 22 correspondingly includes a sliding groove 222, and the sliding rail 232 is accommodated in the sliding groove 222, so that the protective cover 23 can slide relative to the motor housing 22. When the protective cover 3 slides to a certain distance relative to the motor housing 22, the first positioning part 231 and the second positioning part 221 are aligned with each other. An arrangement of the sliding rail 232 and the sliding groove 222 can play a role of an up and down positioning to a certain extent, which facilitates a mounting and fixation of the screw.

A blocking plate 24 is disposed at an end of the motor housing 22 close to the accommodating cavity 220, and the protective cover 23 defines a first edge 233 extending outward. A lower surface of the first edge 233 is higher than an upper surface of the blocking plate 24, so that when the protective cover 23 is assembled to the motor housing 22, the blocking plate 24 can be completely accommodated in the protective cover 23. A configuration of the blocking plate 24 can close a top of the protective cover 23 to prevent debris from entering.

A limiting part 234 is disposed inside the protective cover 23, and when the protective cover 23 is fixedly coupled to the motor housing 22, the limiting part 234 abuts against the blocking plate 24. In some embodiments, the limiting part 234 is a rib disposed inside the protective cover 23. A first end of the rib is fixedly coupled to an inner wall of the protective cover 23, and a second end of the rib is suspended, so that when the protective cover 23 slides relative to the motor housing 22, the rib can always keep abutting against an outer wall of the motor housing 22, so that the protective cover 23 can be stably fixed on the outer side of the motor housing 22.

In this embodiment, the protective cover 23 is substantially square, four inner side walls of the protective cover 23 all defines the ribs, and part of the ribs are fixed on the inner side walls of the protective cover 23 in an overhanging manner, so that a periphery of the motor housing 22 can be positioned.

Please refer to FIG. 9 through FIG. 13, a separating plate 27 is fastened to an end of the motor housing 22 away from the fan 211, so as to cover an end opening of the motor housing 22. Wherein, a clamping part is disposed at an edge of one of the motor housing 22 and the separating plate 27, a mating part is correspondingly disposed at an edge of another one of the motor housing 22 and the separating plate 27, and when the separating plate 27 is assembled to the motor housing 22 from top to bottom, the mating part is matched with the clamping part. In an embodiment, a lower surface of the separating plate 27 is flush with a lower surface of the motor housing 22. This configuration not only enables an overall appearance of the motor assembly 2 to be beautiful, but also does not leave an assembly seam on the motor housing 22 to prevent the water vapor from entering.

In an embodiment, the clamping part is a rib 223 disposed at an edge of the motor housing 22, and the rib 223 extends from top to bottom. The mating part is a groove 271 formed at an edge of the separating plate 27, and the groove 271 also extends from top to bottom. When the separating plate 27 is assembled to the motor housing 22 from top to bottom, the rib 223 is accommodated in the groove 271 and slidable along the groove 271. With this configuration, the separating plate 27 is quickly assembled with the motor housing 22, and a structure is simple and cost is low.

A second edge 273 extending toward the motor housing 22 is disposed at an edge of the separating plate 27, and the second edge 273 is L-shaped to form the groove 271 between the second edge 273 and the separating plate 27. The groove 271 is disposed through the second edge 273 from top to bottom, so that the separating plate 27 can be fixed to the motor housing 22 in a sliding manner.

In an embodiment, one of the motor housing 22 and the separating plate 27 may also be disposed with a guiding rail, and another one of the motor housing 22 and the separating plate 27 may be correspondingly disposed with a rail groove, so that the guiding rail may be accommodated in the rail groove to enable the separating plate 27 to slide relative to the motor housing 22. In this way, an assembly is simpler.

At this time, the clamping part is a protruding rib 224 disposed on the guiding rail, the mating part is a limiting groove 272 disposed on an inner wall of the rail groove, and when the separating plate 27 slides to a distance relative to the motor housing 22, the protruding rib 224 is engaged in the limiting groove 272 to fix the separating plate 27 to the motor housing 22.

Of course, as an embodiment of the disclosure, the clamping part includes the rib 223 and the protruding rib 224, and the mating part includes the groove 271 and the limiting groove 272, so that a positioning and fixation between the separating plate 27 and the motor housing 22 may be realized by a cooperation of the rib 223 and the groove 271 and a cooperation of the protruding rib 224 and the limiting groove 272. Positioning and fixing functions are combined into one, which saves use of other components.

A surrounding cavity 274 is disposed in the separating plate 27, the motor housing 22 correspondingly includes a protruding part 225, and when the separating plate 27 and the motor housing 22 are assembled and fixed, the protruding part 225 is accommodated in the surrounding cavity 274. On one hand, a contact area between the separating plate 27 and the motor housing 22 is enlarged, and on the other hand, the motor housing 22 is fixed to the separating plate 27.

The motor body 21 includes a stop part 26. When the motor housing 22 slides to a certain distance on an outer side of the motor body 21, the motor housing 22 abuts against and positions the stop part 26. In some embodiments, the stop part 26 is a stop plate disposed on the motor body 21, and an upper surface of the stop plate is lower than a lower surface of the protruding part 225. In this way, a sliding distance of the motor housing 22 may be determined.

The stop part 26 is a stepped structure of at least three steps. Wherein, a first step 261 is flush with an upper surface of the motor body 21, a second step 262 is higher than a first step 261 and can be accommodated in the motor housing 22, and an upper surface of the third step 263 is lower than the lower surface of the protruding part 225. A configuration of the three stepped structure enables the stop part 26 to fully contact and be fixed to the motor body 21.

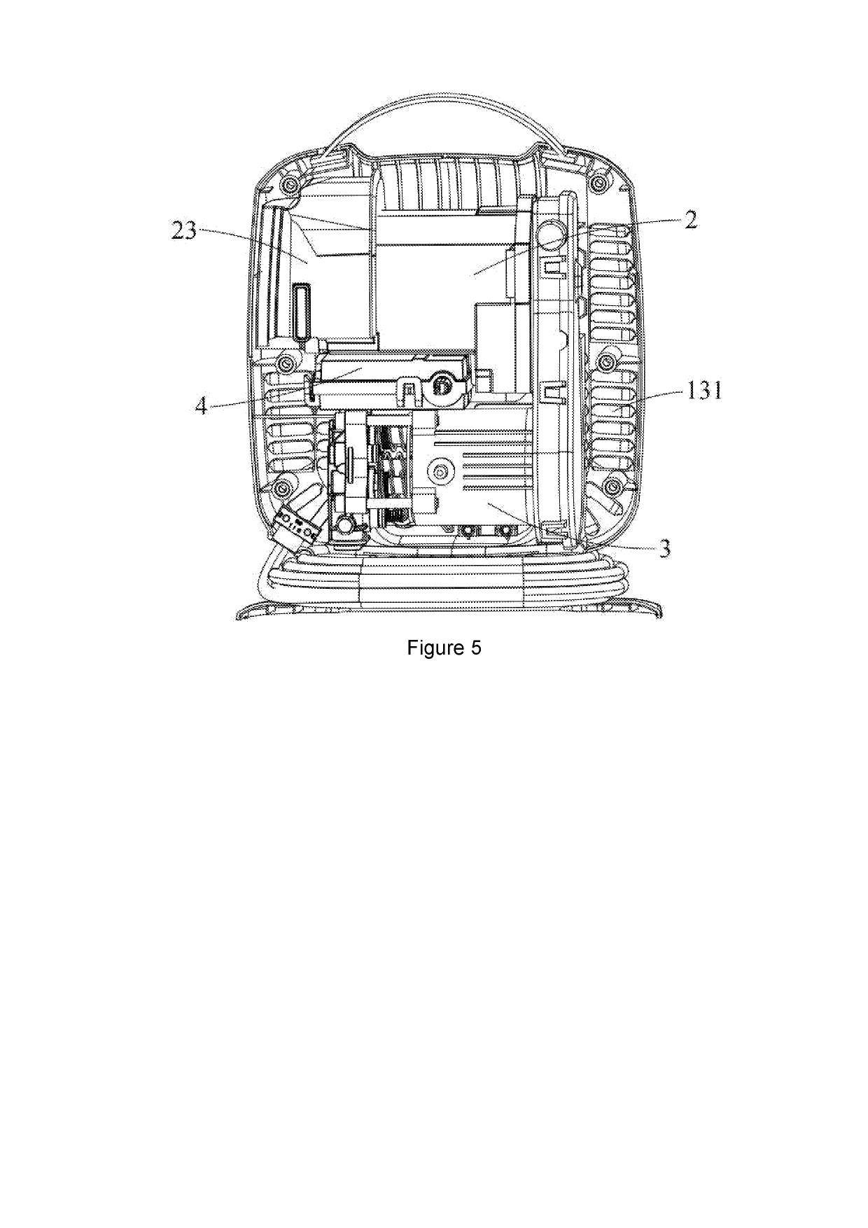

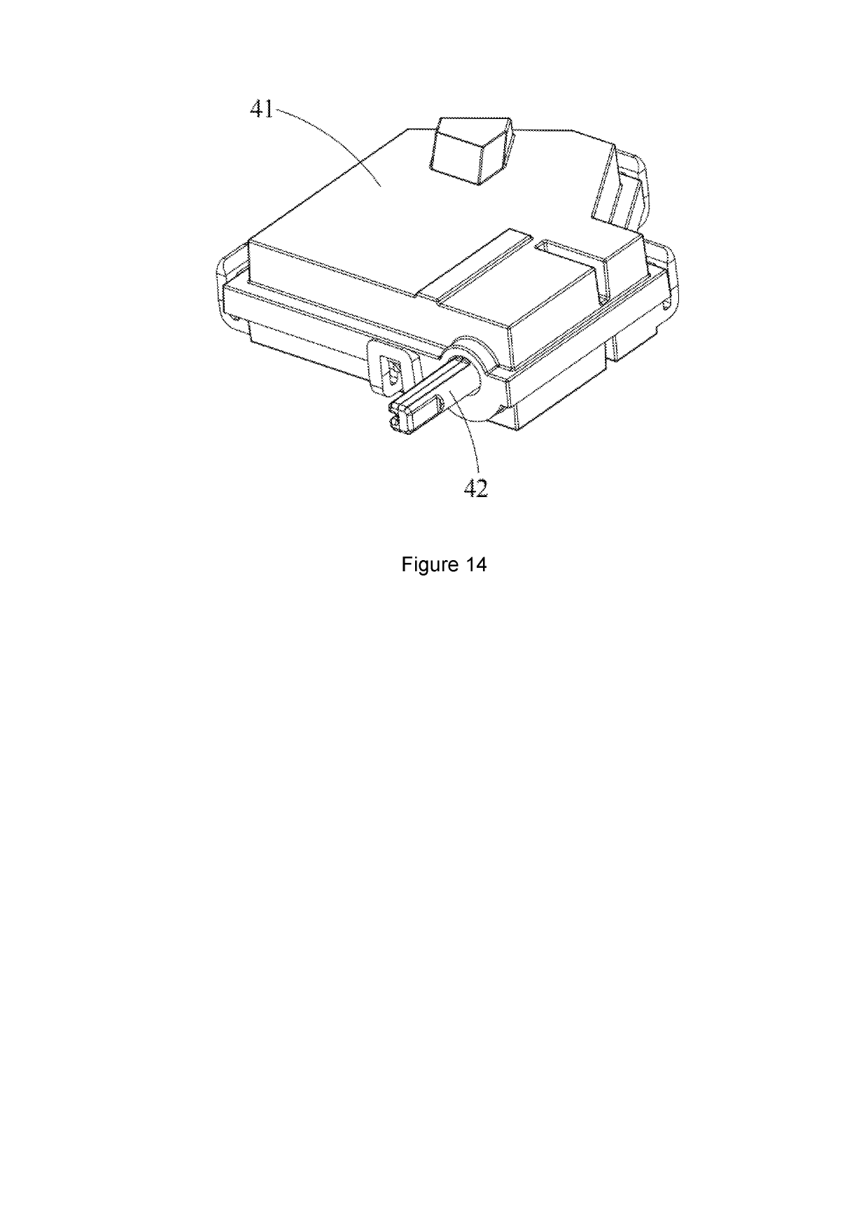

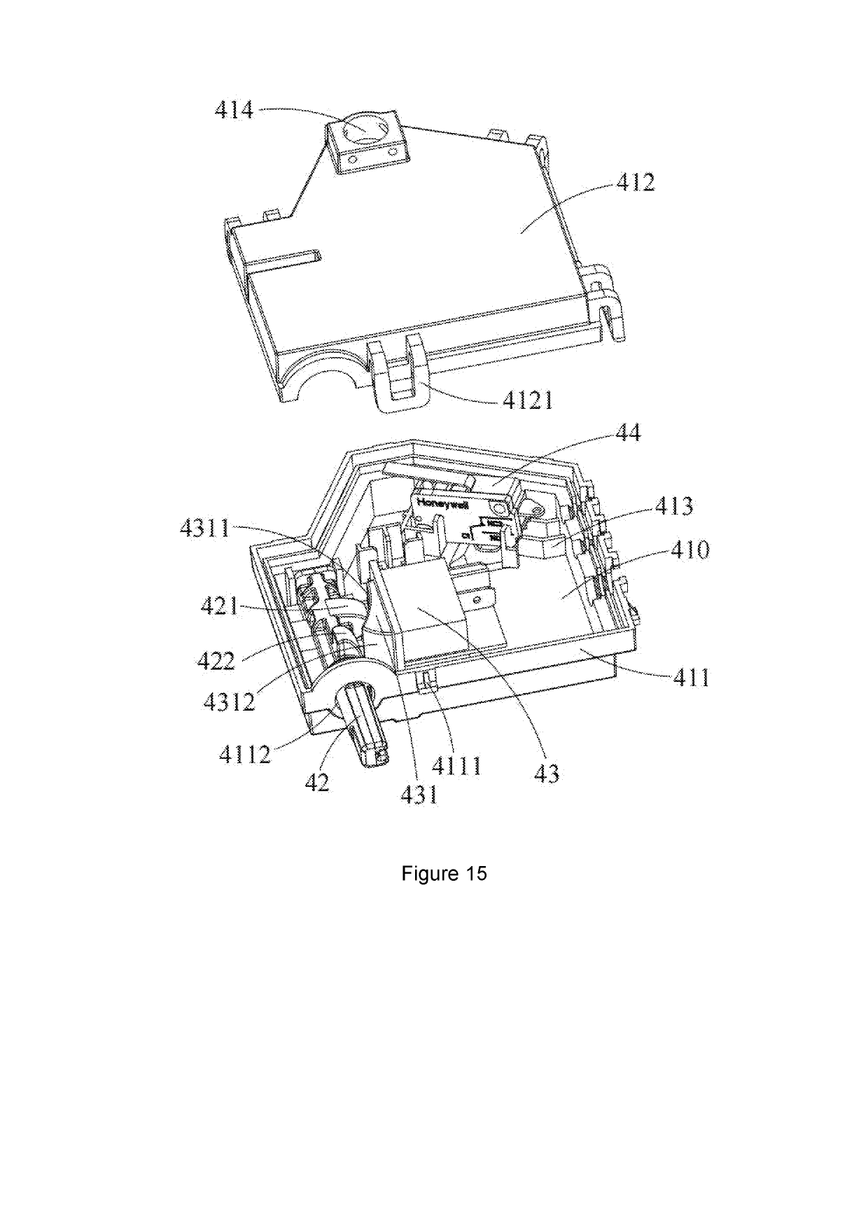

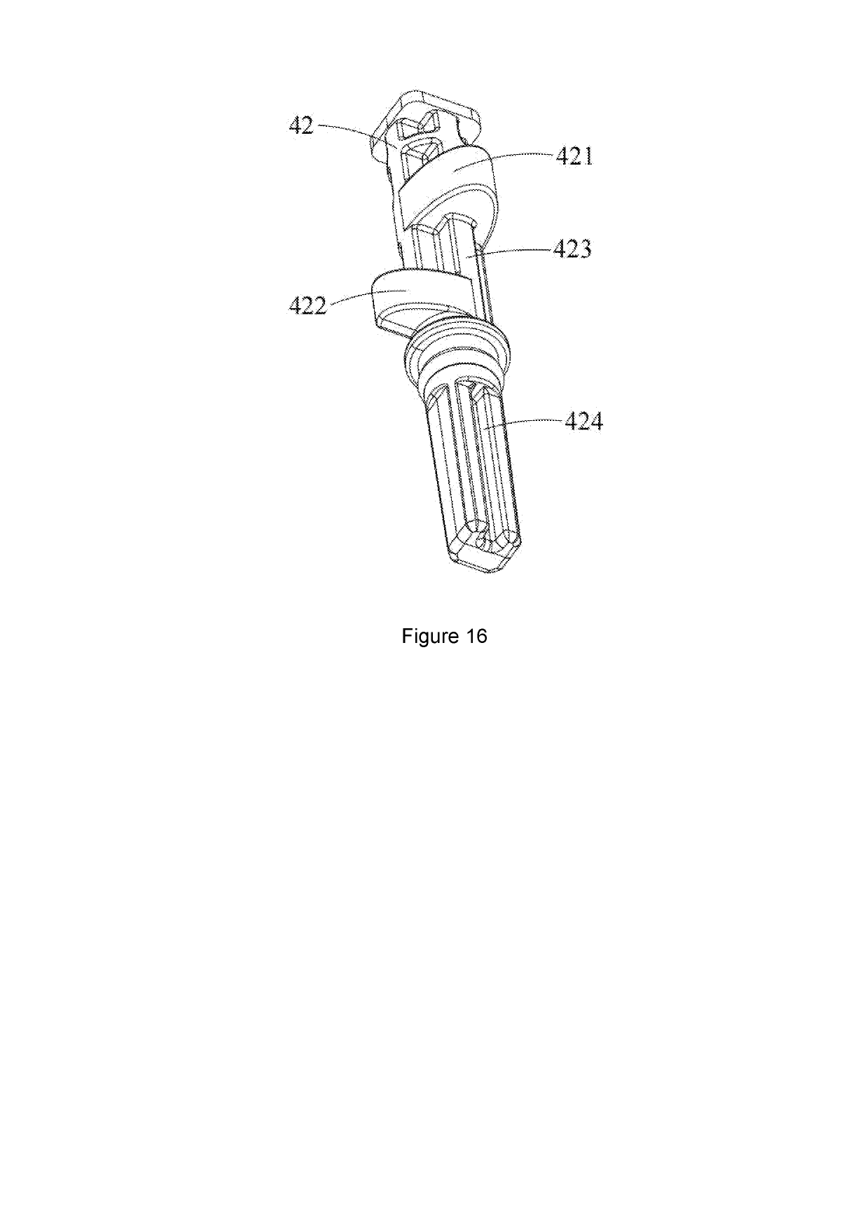

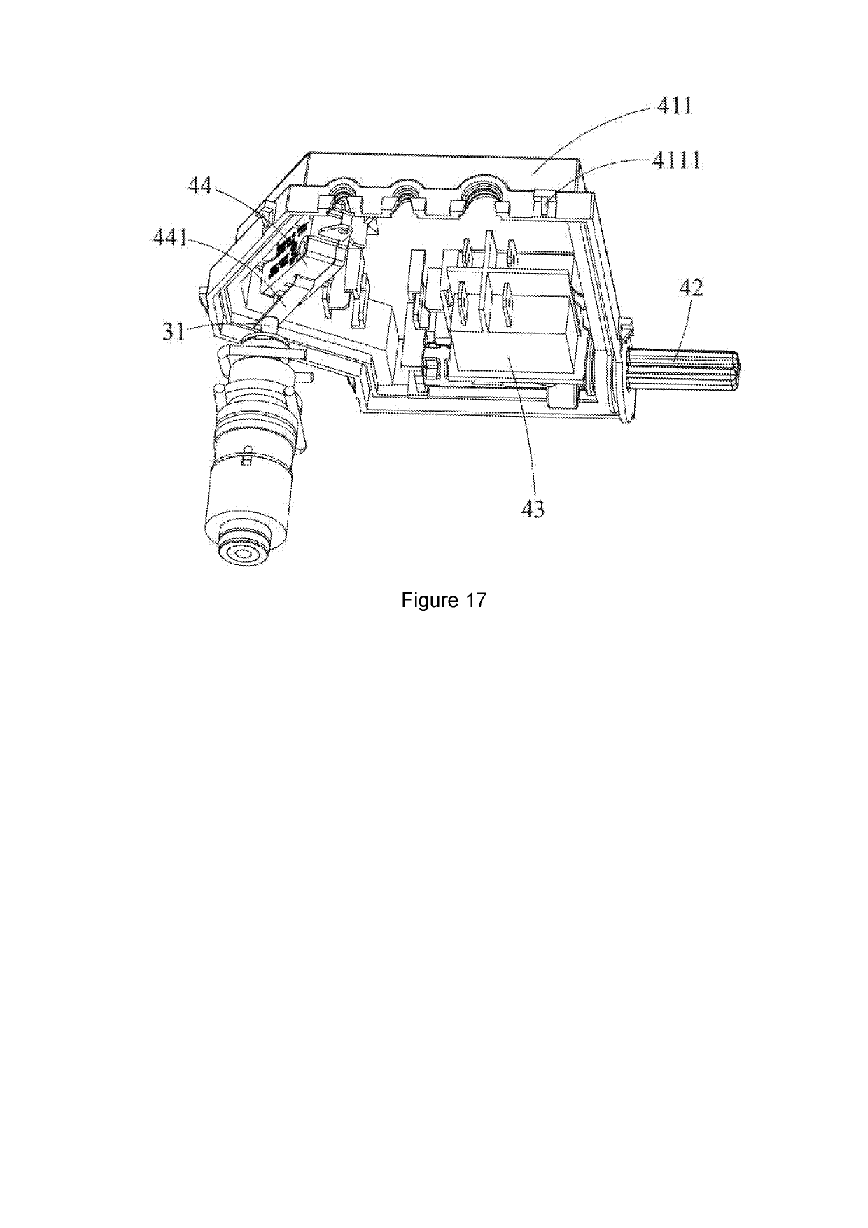

Please refer to FIG. 14 through FIG. 17 combined with FIG. 4 and FIG. 5. The switch assembly 4 is located between the motor assembly 2 and the pump assembly 3, and fixedly coupled to the pump assembly 3 and the housing 1 respectively. With this configuration, a space inside the housing 1 can be saved as much as possible.

The switch assembly 4 includes a box 41, an operating component 42, a first switch component 43 and a second switch component 44. The first switch component 43 and the second switch component 44 are accommodated in the box 41. The first switch component 43 is an on-off switch of a whole machine, and the second switch component 44 is a gun triggering switch. The operating component 42 is coupled to the box 41 and rotatable relative to the box 41. In an embodiment, a first end of the operating component 42 is accommodated in the box 41, a second end of the operating component 42 is located outside the box 41, and the operating component 42 includes a first operating block 421 and a second operating block 422. The first operating block 421 extends in a first direction and the second operating block 422 extends in a second direction. The first switch member 43 includes a switch part 431 facing one side of the operating component 42, and the switch part 431 is switchable between a first state and a second state to activate and deactivate the first switch component 43.

When the first operating block 421 abuts against a first end part 4311 of the switch part 431, a second end part 4312 of the switch part 431 is tilted, the switch part 431 is in the first state, and the first switch component 43 is activated. When the operating component 42 is rotated to enable the second operating block 422 to abut against the second end part 4312 of the switch part 431, the first end part 4311 of the switch part 431 is tilted, the switch part 431 is in the second state, and the first switch component 43 is deactivated.

In this disclosure, the first operating block 421 extends in a first direction and the second operating block 422 extends in a second direction perpendicular to the first direction, and outer wall surfaces of the first operating block 421 and the second operating block 422 on a side facing the switch part are both arc surfaces, which not only increases a contact area, but also facilitates the operating component 42 to control an activation and deactivation of the first switch component 43.

The operating component 42 includes a first part 423 accommodated in the box 41 and a second part 424 located outside the box 41, and the first operating block 421 and the second operating block 422 are both disposed on the first part 423. This means that, through exposing the second part 424 outside the box 41, the operating component 42 can control a start and stop of the first switch component 43 when the switch assembly 4 is in a sealed state.

The box 41 includes a first box 411 and a second box 412. The first box 411 and the second box 412 are assembled with each other to form a mounting space 410, and the operating component 42 and the first switch component 43 are both mounted in the mounting space 410. In an embodiment, the box 41 is detachably assembled by the first box 411 and the second box 412, and at the same time, the first box 411 and the second box 412 are both concave to define an area for placing the first switch component 43 and the operating component 42, and positioning ribs 413 are disposed at a periphery. After the operating component 42 and the first switch component 43 are placed in the box 41, the positioning ribs 413 in the first box 411 and the second box 412 are spliced with each other to fix the first switch component 43 and the operating component 42 in the box 41.

In order to further save a space in the box 41, the first switch component 43 is disposed parallel to the operating component 42 in the mounting space 410.

The first box 411 includes a through groove 4112 for the operating component 42 to pass through, a latching block 4111 protrudes from an outer side wall of the first box 41, a buckling part 4121 is correspondingly disposed on an outer side wall of the second box 412, and the buckling part 4121 is engaged with the latching block 4111 to assemble and fix the first box 411 with the second box 412. There are various ways to fix the first box 411 and the second box 412, and in this embodiment, the latching block 4111 and the buckling part 4121 are used for fixing, which has a simple structure and is relatively universal. Of course, in other embodiments, other fixing methods may also be used, as long as a disassembly can be ensured when needed.

As a connection manner between the switch assembly 4 and the pump assembly 3, in this embodiment, the second switch member 44 includes a cantilevered elastic arm 441, a pre-made hole 414 is opened on a side of the box 41 facing the pump assembly 3, and a portion of the elastic arm 441 is exposed to the pre-made hole 414. The pump assembly 3 includes a control part 31, and the control part 31 extends into the pre-made hole 414 to abut against the elastic arm 441 to activate or deactivate the second switch component 44.

With this configuration, not only the on-off switch of the whole pressure washer and the gun triggering switch separately placed in a traditional design can be stored in the box 41 at the same time, but also the motor assembly 2 can be fixedly coupled to the pump assembly 3 through the box 41, which saves a lot of space and saves production costs.

A rotating component 16 is fixed at one end of the operating component 42 located outside the box 41, the housing 1 defines a rotating hole 17 adapted to the rotating component 16, and a portion of the rotating component 16 passes through the rotating hole 17 and rotatable in the rotating hole 17 to drive the operating component 42 to rotate. With this configuration, the operating component 42 can be driven to rotate through rotating the rotating component 16 outside the housing 1, and then the on-off switch of the whole machine can be activated or deactivated, so that a start and close of the pressure washer is realized, and an operation is convenient.

In summary, the pressure washer of the disclosure has following effects:

1. through a longitudinal configuration of the motor assembly 2 and pump assembly 3, and fixing the switch assembly 4 between the motor assembly 2 and pump assembly 3 and coupling the switch assembly 4 to both the pump assembly 3 and the housing 1 fixedly, an internal structure of the pressure washer of the disclosure is more compact, which not only increases a utilization rate of the internal space, but also greatly reduces a volume of the pressure washer, thereby making it more convenient to be carried and moved;

2. through covering the protective cover 23 at one end of the motor housing 22 with the accommodating cavity 220, the fan 211 accommodated in the accommodating cavity 220 is completely covered, at the same time, the cover plate 6 is mounted outside of the housing 1 of the pressure washer to at least partially cover the air inlet 131, which reduces the noise transmitted out of the pressure washer during a working process, reduces the water vapor entering the pressure washer from the air inlet 131, and plays a role of moisture resistance and noise reduction;

3. through pushing the control component 152 to move toward one side of the hose port 151, the second end 1532 of the fixing member 153 is pushed until the fixing part 1533 moves toward the outside of the positioning cavity 1512, at this time, the high-pressure hose connector may be inserted into the plug-in cavity, when the control component 152 is released, the control component 152 can be automatically reset under the restoring force of the fixing member 153, so that the fixing part 1533 is re-accommodated in the positioning cavity 1512 to tighten the high-pressure hose connector, the high-pressure hose connector is fixed in the plug-in cavity 1511, and a fixed connection between the hose port 151 and the high-pressure hose connector is realized, which enables the fixation to be more stable;

4. through fixing the separating plate 27 at the end of the motor housing 22 away from the fan 211, the end opening of the motor housing 22 is completely covered to prevent the water vapor from penetrating into the motor housing 22 which may cause the motor to rust;

5. through rotating the operating component 42 accommodated inside the box 41 and coupled to the box 41, the first operating block 421 and the second operating block 422 extending in different directions disposed on the operating component 42 respectively abut against two ends of the switch part 431 also accommodated inside the box 41, so that the switch part 431 can be switched between the first state and the second state to activate and deactivate the first switch component 43, which can effectively increase a utilization rate of space and reduce production cost.

Although the disclosure has been described in detail with reference to the preferred embodiments, those skilled in the art should understand that technical solutions of the disclosure can be modified or equivalently replaced without departing from a spirit and scope of the technical solutions of the disclosure.

What is claimed is:

1. A pressure washer, comprising:
a housing;
a motor assembly disposed within the housing;
a pump assembly disposed within the housing, the motor assembly and the pump assembly being configured to be arranged longitudinally;
a switch assembly located between the motor assembly and the pump assembly, and fixedly coupled to the pump assembly and the housing respectively; and
a hose fixing device mounted on the housing to fix a hose connector;
wherein the pump assembly is coupled to the hose connector to pump an external water source to the pressure washer and discharge water out of a water outlet pipeline of the pressure washer.

2. The pressure washer according to claim 1, wherein the housing comprises a first housing and a second housing assembled with each other, the first housing and the second housing define an accommodating space, an air inlet and an air outlet are disposed on the first housing and/or the second housing, and airflow enters the accommodating space from the air inlet and exits from the air outlet.

3. The pressure washer according to claim 2, wherein, the motor assembly comprises:
a motor housing, an accommodating cavity being disposed at one end of the motor housing;
a motor body at least partially disposed in the motor housing;
a fan coupled to the motor body and being located in the accommodating cavity ; and
a protective cover located at an end of the motor housing where the accommodating cavity is disposed, the protective cover being fixedly coupled to the motor housing.

4. The pressure washer according to claim 3, wherein the air inlet is disposed on a side of the housing away from the fan, and a separating part is disposed between the air inlet and the air outlet to make the airflow air inlet enters the accommodating space before exiting from the air outlet.

5. The pressure washer according to claim 4, wherein the air outlet comprises a first air outlet and a second air outlet, the first air outlet is disposed on a side of the housing close to the fan, the second air outlet is disposed at a bottom of the housing, and the separating part is disposed between the air inlet and the second air outlet.

6. The pressure washer according to claim 3, wherein a blocking plate is disposed at an end of the motor housing close to the accommodating cavity, the protective cover defines a first edge extending outward, a limiting part is disposed inside the protective cover, and when the protective cover is fixedly coupled to the motor housing, the blocking plate is accommodated in the protective cover and the limiting part abuts against the blocking plate.

7. The pressure washer according to claim 1, wherein, the hose fixing device comprises:
a hose port coupled to the hose connector; and
a control component disposed on one side of the hose port;
wherein the hose connector is operately locked and unlocked by the control component .

8. The pressure washer according to claim 7, wherein a positioning cavity is disposed on an outer side wall of the hose port,
the hose fixing device further comprises a fixing member, the fixing member passes through the positioning cavity, a first end of the fixing member is fixed, a second end of the fixing member abuts against the control component, and the fixing member further comprises a fixing part coupling the first end to the second end;
when the hose connector is released, the second end of the fixing member is pushed by an external force to cause the fixing part to be away from the positioning cavity, and when the hose connector is locked, the second end of the fixing member is free from the external force to allow the fixing part to remain in the positioning cavity.

9. The pressure washer according to claim 8, wherein the housing has a first opening and a second opening, the control component is accommodated in the housing and passes through the first opening, and the hose port is accommodated in the housing and is exposed from the second opening.

10. The pressure washer according to claim 9, wherein the control component comprises a base part and a pushing part coupled to the base part, the base part comprises a pushing block, the pushing block passes through the first opening, a contacting surface between the pushing part and the second end of the fixing member is an inclined surface, and when the pushing block is pushed, the control component is pushed to move toward one side of the hose port to cause the second end of the fixing member to slide along the contacting surface.

11. The pressure washer according to claim 8, wherein the fixing part extends along a pushing direction of the control component, both the first end and the second end extend along the insertion direction of the hose connector, and both the first end and the second end are substantially perpendicular to the fixing part.

12. The pressure washer according to claim 3, wherein a separating plate is fixed at an end of the motor housing away from the fan, a clamping part is disposed at an edge of one of the motor housing and the separating plate, a mating part is correspondingly disposed at an edge of another one of the motor housing and the separating plate, and when the separating plate is assembled to the motor housing from top to bottom, the mating part is matched with the clamping part.

13. The pressure washer according to claim 12, wherein the clamping part is a rib disposed at an edge of the motor housing, the rib extends from top to bottom, the mating part is a groove formed at an edge of the separating plate, the groove also extends from top to bottom, and when the separating plate is assembled to the motor housing from top to bottom, the rib is accommodated in the groove and slidable along the groove.

14. The pressure washer according to claim 12, wherein one of the motor housing and the separating plate is disposed with a guiding rail, another one of the motor housing and the separating plate correspondingly is disposed with a rail groove, the guiding rail is accommodated in the rail groove, the clamping part is a protruding rib disposed on the guiding rail, the mating part is a limiting groove disposed on an inner wall of the rail groove, and when the separating plate slides to a distance relative to the motor housing, the protruding rib is engaged in the limiting groove to fix the separating plate to the motor housing.

15. The pressure washer according to claim 1, wherein, the switch assembly comprises:
a box;
an operating component, coupled to the box and rotatable relative to the box, a first end of the operating component being accommodated in the box, a second end of the operating component being located outside the box, and the operating component comprises a first operating block and a second operating block extending in different directions; and
a first switch component, accommodated in the box, the first switch member comprising a switch part facing one side of the operating component, and the switch part being switchable between a first state and a second state to activate and deactivate the first switch component;
wherein, when the first operating block abuts against a first end part of the switch part, a second end part of the switch part is tilted, the switch part is in the first state, the first switch component is activated, and when the operating component is rotated to enable the second operating block to abut against the second end part of the switch part, the first end part of the switch part is tilted, the switch part is in the second state, and the first switch component is deactivated.

16. The pressure washer according to claim 15, wherein, the first operating block extends in a first direction and the second operating block extends in a second direction perpendicular to the first direction, and outer wall surfaces of the first operating block and the second operating block on a side facing the switch part are both arc surfaces.

17. The pressure washer according to claim 15, wherein a second switch component is further accommodated in the box, the second switch component comprises a cantilevered elastic arm, a pre-made hole is formed on a side of the box facing the pump assembly, a portion of the elastic arm is exposed to the pre-made hole, the pump assembly comprises a control part, and the control part extends into the pre-made hole to abut against the elastic arm to activate or deactivate the second switch component.

18. The pressure washer according to claim 15, wherein a rotating component is fixed at one end of the operating component located outside the box, the housing defines a rotating hole adapted to the rotating component, and a portion of the rotating component passes through the rotating hole and rotatable in the rotating hole to drive the operating component to rotate.

19. The pressure washer according to claim 15, wherein, the operating component comprises a first part accommodated in the box and a second part located outside the box, and the first operating block and the second operating block are both disposed on the first part.

20. The pressure washer according to claim 15, wherein the box comprises a first box and a second box, the first box and the second box are assembled with each other to form a mounting space, the operating component and the first switch component are both mounted in the mounting space, the first box comprises a through groove for the operating component to pass through, a latching block protrudes from an outer side wall of the first box, a buckling part is correspondingly disposed on an outer side wall of the second box, and the buckling part is engaged with the latching block to assemble and fix the first box with the second box.
